(19) United States
(12) Patent Application Publication
(10) Pub. No.: US 2006/0141940 A1
(43) Pub. Date: Jun. 29, 2006

(54) Intelligent bridge between PSTN and asynchronous communication channel

(76) Inventors: David L. Bloom, Louisville, KY (US); William I. Basser, North Adams, MA (US)

Correspondence Address: FROST BROWN TODD, LLC, 2200 PNC CENTER, 201 E. FIFTH STREET, CINCINNATI, OH, 45202, US

(21) Appl. No.: 11/248,502

(22) Filed: Oct. 12, 2005

Related U.S. Application Data
(60) Provisional application No. 60/617,914, filed on Oct. 12, 2004.
(60) Provisional application No. 60/665,001, filed on Mar. 24, 2005.

(51) Int. Cl. H04B 1/38

(52) U.S. Cl. 455/73

(57) ABSTRACT

An intelligent communications bridge device (“Meterpod”) of a remote Supervisory Control and Data Acquisition (SCADA) system advantageously facilitates monitoring, reporting and control of public utility meters. The Meterpod is an intelligent gateway that installs onto existing metering and monitoring equipment and provides a wireless communications link from the remote equipment being monitored or controlled to the host computer or program tracking or controlling the device providing clear advantages over existing remote telemetry equipment in that it can (1) support any wireless communications protocol, including CDMA, GSM/GPRS, VSAT, and GPRS standards, (2) be installed and configured in minutes by regular maintenance personnel, and (3) provide control capabilities beyond the remote device by utilizing a broad array of additional interfaces (RJ-11, Ethernet, RS-232 and RS-485) that all come standard, supporting customer sites that cannot be monitored using existing fixed wireless or radio frequency (RF) monitoring solutions.

### CROSS REFERENCE TO RELATED APPLICATIONS

The present application hereby claims the benefit of and hereby incorporates by reference in its entirety the U.S. provisional patent application entitled “INTELLIGENT BRIDGE BETWEEN PSTN AND ASYNCHRONOUS COMM CHANNEL”, Ser. No. 60/617,914, filed on 12 Oct. 2004. The present application also hereby claims the benefit of and hereby incorporates by reference in its entirety the provisional patent application entitled “INTELLIGENT BRIDGE BETWEEN PSTN AND ASYNCHRONOUS COMM CHANNEL INCORPORATING KEYPAD INTERFACE”, Ser. No. 60/665,001, filed on 24 Mar. 2004.

### FIELD OF THE INVENTION

The present invention relates, in general, to devices that perform remote Supervisory Control and Data Acquisition (SCADA) and, in particular, to such devices used to monitor, report and control public utility meters and, specifically, the gathering of usage information in Automatic Meter Reporting.

### BACKGROUND OF THE INVENTION

Remote monitoring, metering, and control capabilities and technologies for various kinds of systems management have developed rapidly in the last 10 years. From the earliest radio frequency automated meter reading equipment applications in the 1990's, the ability for analog measurement and monitoring devices to transmit data reliability and affordably back to a central hub has been the most critical and challenging aspect of deploying these services over time. As these devices have evolved, they still remain expensive, platform or protocol dependent, and unreliable in harsh field environments. Further, recent US regulatory developments regarding the discontinuation of the analog cellular band for telecommunications purposes have only increased the need for a stable, long term remote device control solution that is communications protocol platform-independent. US utility companies are actively engaged in assessing alternatives and replacement options for their analog cellular bag phones that are attached to industrial meters and which represent a part of their overall SCADA infrastructure. The current technology, analog cellular, provides for connection using a limited bandwidth as this technology communicates in the voice bandwidth. In addition, no data awareness or data modification can be performed with this technology.

Electric, gas and water utilities worldwide have historically utilized 1980's style analog cellular bag phones to obtain automated and real-time meter reads from remote industrial meters. The Federal Communications Commission (FCC) has modified or eliminated various rules that became outdated due to supervening rules, technological change, or increased competition among providers of Commercial Mobile Radio Services (CMRS). Among the rule changes adopted by the Commission were the amendment of sections 22.901 and 22.933 of FCC rules to modify the requirement that cellular carriers provide analog service compatible with Advanced Mobile Phone Service (AMPS) specifications by establishing a five-year transition period after which the analog standard would not be required, but could still be provided. Utilities, anticipating that the infrastructure and network that supported its analog bag-phone replacement technologies would be going away, immediately became actively engaged in assessing alternatives to its current installed technology. This segment consists of about 100 investor-owned utilities, some 200 municipal utilities, and a number of other utility companies with over 400,000 US industrial meters requiring retrofit.

The remote telemetry device market encompasses a broad spectrum of applications and opportunities, including cellular bag phone replacement (BPR), SCADA, remote device and monitoring control including compressor, HVAC, manufacturing, security, environmental, lighting, backup power and systems management devices, as well as Programmable Logic Control (PLC) driven devices that interface into existing local area networks. The BPR application has greatest urgency and potential value add as a result of the FCC allowing for analog cellular networks to be sunset tentatively by 4th quarter 2007. The majority of existing automated meter reading (AMR) platforms that utilize the cellular network for device communications require the use of analog cellular bandwidth to function. With nearly 10 million analog industrial meters in place in the US, the market for this application alone is immense. However, as the industry does not have a single messaging protocol, problems arise when two dissimilar systems attempt to communicate. In addition, all data is typically sent in a non-secure manner.

Consequently, a significant need exists for a communication bridge that asynchronously interfaces between an analog device and a wireless digital cellular network.

### SUMMARY OF THE INVENTION

The invention overcomes the above-noted and other deficiencies of the prior art providing a communication bridge that intelligently interfaces between an analog device such as a utility meter and asynchronously communicates across a wireless digital communication channel to a cellular telephone network. Thereby, remotely distributed devices may be monitored and/or controlled from a central location, even if the remotely distributed devices have rudimentary, analog communication capabilities.

These and other objects and advantages of the present invention shall be made apparent from the accompanying drawings and the description thereof.

### BRIEF DESCRIPTION OF THE FIGURES

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a block diagram of a remote Supervisory Control and Data Acquisition (SCADA) system incorporating an intelligent bridge device (“Meterpod”) consistent with the present invention.

FIG. 2 is a block diagram of a controller of the Meterpod device of FIG. 1.

FIG. 3 is a block diagram of the controller of the Meterpod device of FIG. 1.

FIG. 4 is a block diagram of the controller of the Meterpod device of FIG. 1.

FIG. 5 is a block diagram of a coupler of the controller of FIG. 4.

FIG. 6 is a block diagram of a switch of the controller of FIG. 4.

FIG. 7 is a block diagram of a Public System Telephone Network (PSTN) simulator of the controller of FIG. 2.

FIG. 8 is a flow chart detailing the incoming call processing state machine performed by the controller of FIG. 2.

FIG. 9 is a flow chart detailing the outgoing call processing state machine reformed by the controller of FIG. 2.

### DETAILED DESCRIPTION OF THE INVENTION

Remote Supervisory Control and Data Acquisition (SCADA) allows the gathering of information from a remote device by providing an intelligent microprocessor controlled bridge between the digital cellular network and a local connection, either an analog modem or a standard communications bus. The acquisition of data from a remote device begins with an incoming call being received from a remote host computer. The bridge detects this incoming call and proceeds to establish a connection to the local device. Once this connection has been established, incoming and outgoing data is routed between the two devices. The communications data rates between the two devices are dissimilar and the present invention provides buffering to accommodate this issue.

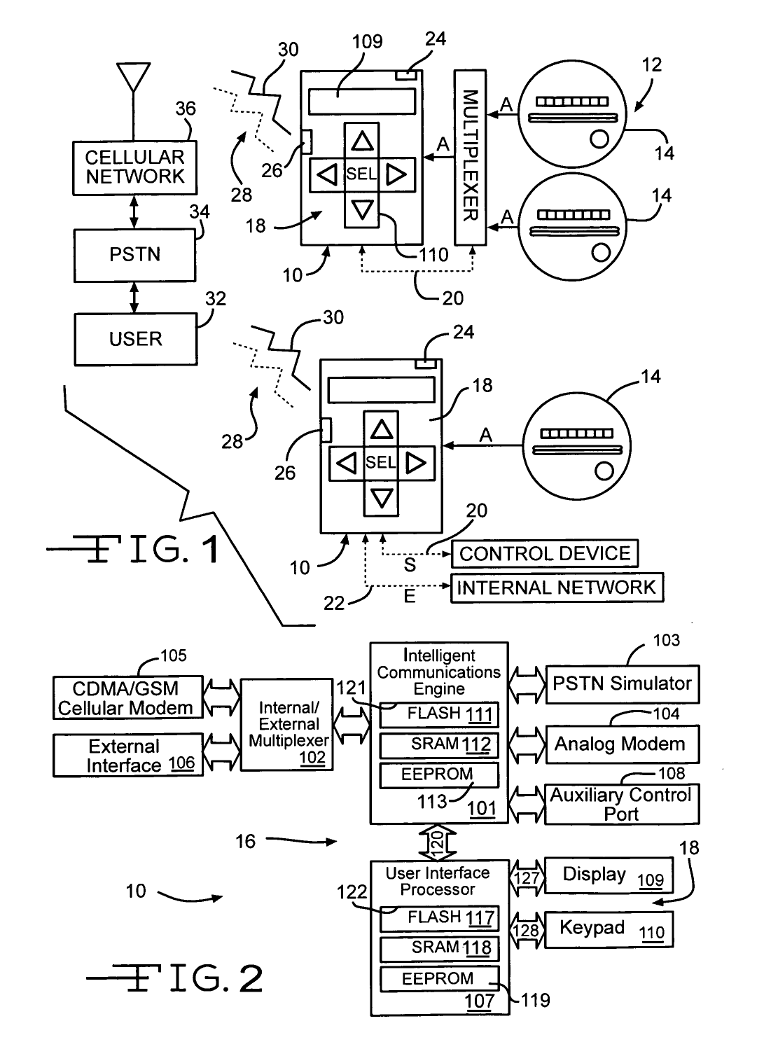

Turning to the Drawings, wherein like numerals denote like components throughout the several views, in FIG. 1, an intelligent communications bridge device (“Meterpod”) 10 of a remote Supervisory Control and Data Acquisition (SCADA) system 12 advantageously facilitates monitoring, reporting and control of a local vice, depicted as public utility meters 14.

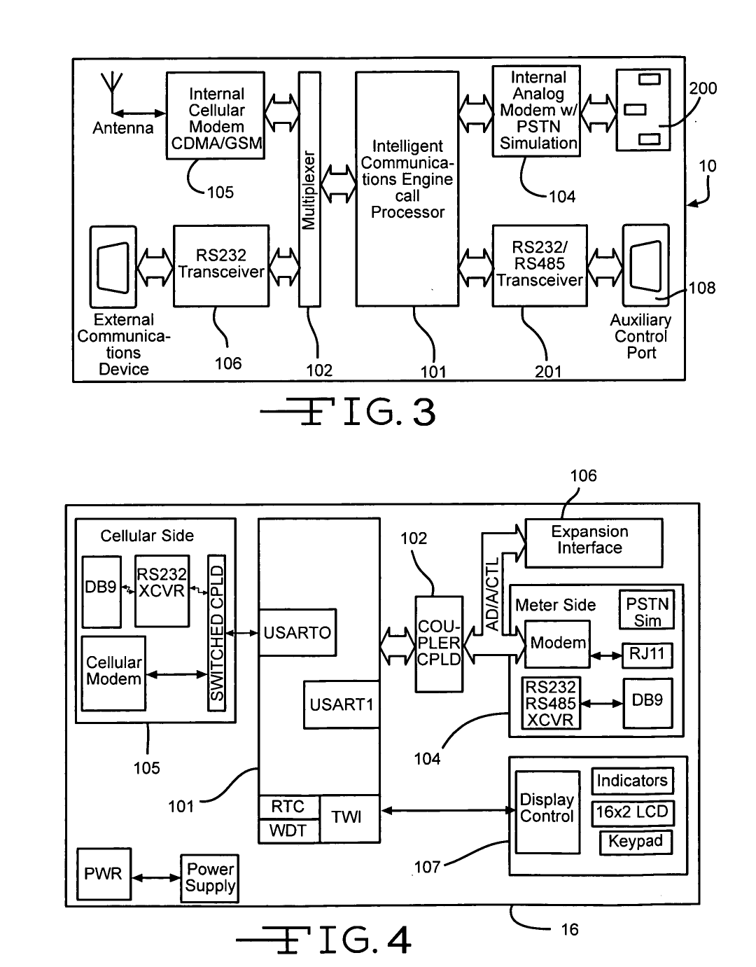

The intelligent communications bridge 10 controls call handling and processing with extended error and event logging that allows failures to be analyzed intelligently. The Meterpod device 10 controls the data flow between the two dissimilar technologies with buffering to prevent data overflows. A control system 16 (FIG. 2) of the Meterpod device 10 has the ability to modify the incoming and outgoing data to allow for protocol conversion as well as data security by adding encryption/decryption capabilities. The Meterpod device 10 also provides an integrated user interface 18, depicted as a keypad 110 and display (e.g., LCD) 109, which allows for local setup, error and event log review and maintenance and diagnostics. The Meterpod device 10 also provides inclusive connection to two types of devices locally, an analog modem 20 and an industry standard RS232/RS485 communications bus 22. The Meterpod device 10 also provides full redundancy by adding an exclusive external communications channel 24 which can be used if an internal cellular connection 26 fails or is an area with no coverage. This redundancy provides mission critical performance when needed.

Local data acquisition and storage for later automatic reporting may use either a switched data call 28 or short message services 30, the latter offering cost savings to the end user. Thereby, a remote host computer (“user”) 32 may interact (i.e., monitor and/or control) the Meterpod device 10 via a Public System Telephone Network (PSTN) 34 over a cellular digital network 36.

Another embodiment of the present invention provides for packet operation in the existing stream oriented message protocols. The unit provides for the packetization/de-packetization of the incoming and outgoing data. The existing host interrogation protocol does not support message segmentation.

In FIG. 2, one version of the controller 16 implements and manages the intelligence of the Meterpod device 10. The controller 16 includes an intelligent communications engine element 101, which acts as a central processing element, and a user interface processing element 107, which handles the user interface 18. Each intelligent communications engine element 101 and the user interface processing element 107 may include or access computer readable memories (e.g., RAM, EEPROM, FLASH, external magnetic storage device or other computer readable memory known in the art. In the illustrative version, the intelligent communications engine element 101 may access on-chip FLASH memory 111, on-chip EEPROM memory 113, and on-chip SRAM 112. User interface processing element 107, which communicates with the intelligent communications engine 101 via a standard interface controller bus 120, may access on-chip FLASH memory 117, on-chip EEPROM memory 119 and on-chip SRAM 118. Each of the FLASH memories 111, 117 may store a set of computer readable instructions 121, 122 respectively that are executable by their respective processors 101, 107.

The controller 16 may include a cellular modem 105, an analog modem 104, an internal/external communications switch 102, and a PSTN Simulator 103. The internal/external communications multiplexer 102 switches between the internal cellular modem 105 and an external interface 106 to an external device (not shown) to provide for redundant communications (e.g., via the exclusive external communications channel 24 of FIG. 1). The Public Systems Telephone Simulator 103 provides the necessary signal voltages, ring tone generation, call progress tones and Dual Tone Multi-Frequency (DTMF) (telephony) encoding/decoding. This PSTN simulator 103 allows any standard analog modem communications device to be attached to the Meterpod device 10. An auxiliary control port 108 provides an additional communications path to an external device 16 using either an RS232 or RS485 communications signaling protocol.

The user interface processing element 107 interfaces to the Liquid Crystal Display 109 via a parallel control bus 127. The display element 109 provides human readable feedback to indicate operational status, call progress and parametric modifications.

The user interface processing element 107 interfaces to the keypad element 110 via a parallel control bus 128. The keypad element 110 allows user input to control operation of the Meterpod device 10 as well as parametric setup and system initialization.

The actual operation of a normal communications session is the detection of an incoming cellular call. The communications engine 101 determines this state and brings a connection sequence to the designated device. If the auxiliary control port 108 has been parametrically selected as the communications device 105,106, the incoming call is immediately answered and the call processor 101 enters a connected state.

If the analog modem 104 has been parametrically selected as the communications device, the PSTN simulator 103 is commanded a dial tone. The analog modem 104 is commanded to generate an outgoing call. The communications engine (call processor) 101 then commands the PSTN simulator 103 to generate a ring voltage. The call processor 101 waits for the attached device (e.g., 32 in FIG. 1) to go off hook. If this condition is detected, the call processor 101 then waits for the analog modem 104 to determine signal connectivity at the selected baud rate and modem technology as parametrically selected. If the units negotiate a connection, the call processor 101 commands the cellular modem 105 to answer and enters a connected state.

All data that is received from the cellular modem 105 is run through a packet filter to determine if this packet is a command to Meterpod device 10 to enter a maintenance mode. All data is passed to the selected designated local port, either the analog modem 104 or the auxiliary control port 108. Data received from the external device 14 is routed to the cellular modem for transmission back to the remote host computer 32.

Any disparity of communication bit rates is accommodated by the local buffering of the communication engine 101. This allows either devices 14, 32 to operate at their highest efficiency that is provided by both the cellular network and the local device.

At any time during the processing of the call connection sequence, if an error is detected, then an event/error is created in the local log. This log is capable of handling a significant number of entries (e.g., 300 or more) entries and the oldest will be overwritten if this queue becomes full. All entries are date and time stamped to provide a historical record of both events and errors for further evaluation as required. In addition, all parametric changes are recorded as well, storing the previous and new settings appropriately.

The various modes of operation of the Meterpod device 10 are determined by programmable parameters stored in the electrically erasable, programmable read only memory. These parameters determine various timeouts and other adjustable settings as well. The parameters are modifiable from the user interface 18 and from the auxiliary control port 108 when set to maintenance mode.

All parametric settings may also be set from the cellular modem (interface) 105. This mode is entered by the detection of a unique message stream by the packet filter. Upon entering the maintenance mode from the cellular side, parameters can be read and written, the error and event log can be displayed, the error and event log can also be cleared. Parameters can be reset back to their factory default settings.

The first example is where the Meterpod device 10 is connected to a local device 14 attached to the analog modem 104. This provides the acquisition of data from this local device 14 by the remote host 32. All commands to acquire this data are provided by the host communications via the cellular connection 28, 30 to the attached local device 14. In this particular mode, the Meterpod device 10 contains no protocol knowledge and allows the data to pass between the two devices 14, 32 unmodified. This mode is the most basic and simplest use of the Meterpod device 10. The communications engine 101 provides call processing and data buffering.

In the second example, the Meterpod device 10 is connected to a local device 14 attached to the analog modem 104 with a secondary device (not shown) connected to the auxiliary control port 108. In this example, the Meterpod device 10 will connect to the analog modem 104 normally. Incoming data received from the cellular modem 105 is run through a message filter to determine if a command has been issued to cause the subsequent data to be routed to the auxiliary control port 108 and incoming data from the auxiliary control port 108 will be sent out the cellular modem 105. As per above, the data is continually being filtered to determine if another command has been issued to switch the data path back to the analog modem 104. This dual mode allows multiple local devices 14 to be interrogated in a single session. In this mode, the communications engine 101 provides data buffering with the addition of command stream filtering to determine the direction of the data flow as well as the detection of the command packet to allow entry into maintenance mode.

The third example is an application where the Meterpod device 10 becomes the controller to acquire data from attached devices on either of the available communication ports, the analog modem 104 or the auxiliary control port 108. This information is locally stored, averaged and processed as designated by the applicable control program being executed in the communications engine 101. Periodically, this data is packetized in the designated manner. At this time, there are two options for transmitting the data back to the host 32. This type of operation is autonomous, with no requirement of the host 32 to trigger the reporting of this data. The cellular modem 105 can be commanded to begin a connection to the host device 32 via a switched data call and upon a successful connection, the data is sent to the host 32.

The second option is to allow the use of Short Message Services which does not require a direct call on the cellular network 36. This mode requires the Meterpod device 10 to have message protocol knowledge and the locations of the data to acquire from the attached local device 14.

The fourth example is where the Meterpod device 10 is connected to a local device 14 attached to the analog modem 104 with a secondary device connected to the auxiliary control port 108. In this example, the Meterpod device 10 detects an off hook connection on the PSTN simulator 103. This causes the call processor 101 to command the analog modem 104 to answer the call. The PSTN simulator 103 will decode the DTMF to determine the outgoing number and the call processor 101 then commands the cellular modem 105 to place an outgoing call to the designated number. Upon a successful connection with the host 32, the Meterpod device 10 enters the connected state. In this mode, the communications engine 101 provides call handling and data buffering.

The fifth example is where the Meterpod device 10 is connected to a local device 14 attached to the analog modem 104 or the auxiliary control port 108. In this example, data connection between the host computer 32 and the Meterpod device 10 is using the packet communications versus the normal stream communications. In this particular mode, the conversion between stream and packet is provided the communications engine 101. This conversion is necessary because of the inability of the host computer 32 to accept responses from the Meterpod device 10 in a segmented manner. This can occur if the data from the attached local device 14 is not handled as a packet. The data acquisition application that is executing at the host computer 32 only has a knowledge of stream operation. This application processes data on a query/response methodology. The response to the host computer 32 has to be complete, in stream mode, which is not an issue as characters are processed on a character by character basis. In packet mode, characters are sent based on the availability of packet space and predetermined buffer timeout. In order to ensure that the response from the Meterpod device 10 is complete, the data is locally buffered in the Meterpod device 10 and sent out as single packet to allow the response to be seen at the remote end as an entire stream. The Meterpod device 10 implements this feature without any knowledge of the messaging protocol that is being used by the remote host computer 32 and the attached local device 14. The Meterpod device 10 provides a local buffer and determines a character timeout time by analyzing the incoming data. Upon detection of this timeout, the data is then sent as a single packet.

The Meterpod device 10 may be housed in a NEMA-4 waterproof and environmentally resistant cover capable of handling harsh outdoor deployments, such as near industrial meters. One distinguishing factor between the Meterpod device 10 and other remote telemetry devices is the display keypad 18 on the front of the Meterpod device 10. The keypad 110 allows for manual, onsite configuration without the need for a laptop. The keypad 110 is designed to be operated with large-gauge safety gloves, which facilitates faster configuration with minimal exposure or risk to other equipment.

The Meterpod device 10 is a remote telemetry communications device that facilitates communication and control to a measurement or control apparatus that cannot utilize other established means of communicating back to a hub or a host through wired telephony, Internet or fixed wireless (i.e. radio frequency) transmissions protocols. The Meterpod device 10 transforms the analog signal from the apparatus into a digital signal capable of being transmitted by any cellular wireless or satellite protocol back to a host terminal, and is capable of transmitting commands from a remote hub back to the Meterpod device 10, enabling remote control and telemetry for apparati for which no communications network is in place. It is specifically used to augment SCADA systems that monitor and control remote industrial processes that cannot communicate with a subset of their remote devices due to the lack of viable communications options to their devices. While it is primarily used as a communication bridge between a network or device hub and a remote monitoring apparatus, the Meterpod device 10 can also be configured to be a remote host for a collection of remote devices that are concentrated in a particular area.

In FIG. 3, the Meterpod device 10 may be installed next to control apparatus and interfaces (not shown) via an RJ-11 connector 200 that simulates PSTN operability to facilitate communications between it and the analog measurement/control device. Alternative interface connections (e.g. Ethernet, RS-232, and RS-485) are also available for the Meterpod, allowing it complete flexibility for connecting with any known communications interface. Call transmission and handling are achieved by the proprietary call processor embedded on the Meterpod. The call processor allows the translation of a PSTN-driven external device to a cellular modem or network data stream that a remote host or on-premise local area network can then transmit effectively to a network control terminal or host management program for the Meterpod device 10. The internal cellular modem can be replaced or augmented with a satellite modem or other internal communications device (VSAT, ISM band radio, etc.). In addition to the traditional cellular modem interface, the Meterpod also supports the emerging SMS technology and TCP/ICP protocols for remote hosts 32. The Meterpod's robust functionality makes it an extremely attractive option for SCADA OEMs that want to provide end-to-end connectivity solutions for their applications, as well as end customers that need to retrofit existing remote telemetry equipment that currently relies on the disappearing analog cellular standard.

The Meterpod is the preferred solution for the bag-phone replacement activities for the following reasons: (1) The Meterpod is communications-protocol independent; it can operate in GSM/GPRS or CDMA environments. Further it can be easily configured to accept VSAT or other satellite communications protocol. (2) The Meterpod translates from the PSTN directly to a cellular modem, thus obviating the need for a digital remote telemetry device AND an analog to digital conversion mechanism to be installed. (3) The Meterpod is remotely configurable via any protocol as well and has the ability to access local area networks at the remote site to deliver host command messages to any device located on the network.

In addition to the analog cellular bag-phone replacement opportunity, the Meterpod device 10 may be attached to any existing SCADA system to interface hard-to-reach remote locations not currently covered by the installed SCADA infrastructure. Historically, industrial processes have utilized SCADA capabilities inside contiguous industrial facilities where access to unlicensed RF, microwave or other wireless infrastructure has allowed ready communications from a remote telemetry unit to a host computer or terminal 32. Increasingly, though, SCADA applications are finding extensions into very remote and hard to reach environments that are not seamlessly covered by wired or wireless communication infrastructure. The Meterpod device 10 provides an immediate and comprehensive communications solution from the host to these very remote telemetry locations without the need for proprietary communications protocol equipment deployment or hardware driver installations. The applications for the Meterpod device 10 include but are certainly not limited to:

New Automated Metering Reading technology utilizes state-of-the-art digital data collection, monitoring, reporting and control, but limits the communications protocol back to the host to fixed wireless platforms. The Meterpod device 10 is a natural and complete complement to the AMR technology in locations for an AMR deployment that cannot be served utilizing the fixed wireless protocol. Some AMR deployments can have the percentage of remote meters to be accessed as a percentage of a full deployment to be as high as 5% of all meters installed. AMR vendors utilizing the Meterpod device 10 may now market an end-to-end solution to their customers instead of a fully integrated solution for 95% of the installed meters and a customized, manually installed solution for the other 5%. The AMR market is extensive and growing in size. The number of AMR units shipped in North America has grown for the fourth year in a row, from approximately 4.1 million in 1998 to 4.9 million in 1999 to 6.1 million in 2000 to 8.1 million in 2001 to 9.5 million in 2002, according to the 7th edition (2004) of “The Scott Report: AMR Deployments in North America

Remote devices and controls for SCADA remote units continue to pose operational problems'for the owners of these systems such as the ability to integrate a flexible communications platform that will give endless configuration options on communications protocols that will achieve connectivity and control to devices that cannot be currently reached by wired or wireless Internet connectivity. Specifically, the following applications represent the most value-added deployments of these capabilities: (1) Water Water Device Management; (2) Remote Environmental (HVAC) and Security Monitoring and Control Systems.

Mobile applications provide yet another application horizon for the Meterpod device 10. Specifically, systems which now use GPS or proprietary analog cellular systems will need to be retrofitted to accommodate the digital cellular standards going forward. According to C. J. Driscoll & Associates' February 2003 Market Study, over one million U.S. fleet vehicles are currently equipped with GPS-based automated vehicle location (AVL) systems. These systems are most extensively used in the long haul trucking and public transit segments, in which 30% - 50% of fleet vehicles are equipped with AVL systems. The number of local commercial fleet vehicles equipped with AVL has more than doubled over the past three years due to the decline in AVL equipment prices, increased availability of reliable wireless communication networks with broad coverage, new entrants into the AVL market with strong products and distribution and other factors. The range of available AVL system configurations has grown from basic, low cost tracking systems to integrated fleet management systems, in which AVL is simply a component. In the future, the increased use of GPS-equipped cellular phones will reduce opportunities for AVL equipment sales, while increasing the need for fleet monitoring and reporting services.

Emerging needs for connectivity are growing with the advent of powerful remote applications that have significant need for communication to a central office or a control host. These applications are just starting to emerge and will likely have rapidly growing needs for flexible remote connectivity capabilities: (1) Information Displays (Billboard data transmission); (2) Vending; (3) Telemedicine; (4) ATM, Remote Kiosk, Point of Sale.

The Meterpod device 10 was not intended to be just a replacement for the current analog bag-phone technology, but a leap forward in providing an intelligent, robust communications link between the cellular and analog worlds. This local intelligence allows the Meterpod device 10 to add further capabilities. The Meterpod operations are controlled by an event driven task scheduler. Events from the various handlers are posted to an event queue. These items are removed from an event queue with higher priority items processed first, then all other items in a first come first served scenario.

The Meterpod has two basic modes of operation: (1) Cellular to Analog link in which the Meterpod only acts to establish communications between the two communications channels. (2) An Intelligent Link in which the Meterpod acts as the controlling node, accessing information from the attached devices, storing them locally and packetizing them for later transmission via a Short Message Services.

The Meterpod operates in a number of modes. In idle mode, in which no activity occurs on either modem connection, cellular or analog. In cellular incoming mode, an incoming call is detected on the cellular modem. This connection can either be a normal connection to the analog modem and/or the network interface or an internal diagnostic/maintenance call. This is determined by sensing for a message that indicates that this connection is a maintenance call; otherwise, it is treated as a normal communications call. In analog incoming mode, an incoming call is detected on the analog modem. This connection is a normal connection and may be processed by initiating a cellular call. In maintenance/diagnostic mode, the mode is initiated from receiving a command packet from either the cellular or network interface channels. This mode is used to update firmware images, for setup of the internal parameters and viewing and for erasing the event and error logs. In transparent mode, data from the cellular modem progresses through the analog modem or network interface and vice-versa. There is no interdiction by the Meterpod in this mode. In call processing-cellular initiated mode, the Meterpod detects an incoming call from the cellular modem by receiving a unsolicited message of type “RING”. This message is decoded and causes an event to be posted to the Call Processing routine. The call processing routine upon detection of an incoming cellular call, sends a command to the cellular modem to answer the incoming call. At this point, a cellular connection to the Meterpod has been established. The call processing routine posts an event to the PSTN handler to initiate a call to the meter via the analog modem. The call processing routine waits until a connection has been established with the meter, however during this time, all incoming characters are stored in a local buffer. These characters are scanned to determine if this connection is meant to be a maintenance call to the internal processor of the Meterpod. If this packet is recognized as a maintenance initiation packet, the PSTN handler is ordered to terminate it's attempt to connect to the meter. If this is not a maintenance packet, the call processor waits for notification that a connection has been made to the meter at which time, all received characters that have been buffered are sent to the meter. At this point all communications occuring between the meter via the analog modem and the cellular modem are transparent to the local intelligence. If for any reason a call cannot be established to the meter, an error message in the appropriate format is sent back across the cellular link indicating that an error has been determined. Upon detection of either the cellular modem hanging up or the analog modem hanging up, the call processor terminates all connections and returns to an idle state. In call processing—meter initiated mode, the PSTN handler detects an off-hook condition. This causes the PSTN handler to issue a command to the Modem handler to go off hook and answer the call. At this time a command is issued to the cellular modem to dial it's internally stored telephone number. Any characters received from the meter during this time are stored in a local buffer for later transmission over the cellular modem. Upon detection that a connection has been made, any stored data is sent out over the cellular modem and the Meterpod device 10 goes into a transparent mode. Upon detection of either cellular modem hanging up or the analog modem hanging up, the call processor terminates all connections and returns to an idle state.

The Meterpod device 10 provides an intelligent bridge between the Public System Telephone Network (PSTN) 34 as it applies to analog modems and the cellular modem network. The Meterpod device 10 also provides both an internal cellular modem 105, either GSM or CDMA technology, as well as secondary external connection to be used with any external wireless communications device, i.e. Satellite, ISM radio, etc.

Scenario 1—Meter Initiated Call. The simplest use of the Meterpod device 10 is between a meter and the cellular network, which is described in the scenario below. The meter is parametrically programmed to dial the host computer to report statistical information. Upon the meter activating it's internal modem, the Meterpod device 10 detects activity on the PSTN and activates the internal modem to begin the connection process to the meter. This occurs with handshake signals to determine modem presence and auto determining the communications baud rate based on each device's capabilities. Once connected, the Meterpod device 10 activates the cellular modem side and dials the host computer. If the connection fails, an error log entry is generated and the process is shut down to allow the meter to retry at a later time. If the connection is successful, the Meterpod device 10 then allows full duplex communication between the meter and the host system via the cellular connection.

Scenario 2—Host Initiated Call: The Meterpod device 10 detects an incoming call from the cellular modem. The Meterpod device 10 generates a ring signal on the PSTN to wake up the meter. Upon wakeup, the Meterpod device 10 establishes communications with the meter using it's internal modem resource. Once again, communications protocols and speeds are established automatically during the connection phase. Once connected, a full duplex path is provided for communications between the meter and the host computer. In all cases, any errors or abnormal conditions detected (i.e. loss of communications, communications errors, etc.) are logged to an internal error log for further review during any maintenance period. This log can be accessed either via the integrated user interface or via a computer connected either to the Network Interface Port or over the cellular connection via special commands.

Scenario 3—Meterpod device 10 Short Message Protocol: In this particular case, the intelligence of the Meterpod device 10 becomes paramount. The Meterpod device 10 acts as the host computer providing the necessary handshakes and protocol authentications to allow this data to be retrieved from the attached meter. This information is stored locally and is then sent over the cellular network using the Short Message System Protocol. This has a distinct advantage as the cellular phone does not have to make a switched data connection. This results in significant savings to the utility companies and the rate charged for this type of service is less. This is a unique feature of the Meterpod device 10.

Scenario 4—Redundant communication systems: The Meterpod device 10 provides dual interfaces, one internal and one external. This application may be used in mission critical applications or applications where the Meterpod device 10 is not stationary. The Meterpod device 10 automatically switches between both the primary and secondary communications devices based on signal quality or connectivity status.

Scenario 5—Non Meter Device: The Meterpod device 10 also provides a secondary communications channel on the modem side that allows for additional device(s) to be connected and controlled in a similar manner. This allows a broad spectrum of devices to be connected to the Meterpod device 10. This may be used in a non meter type application, such as Supervisory Control and Data Acquisition (SCADA).

In all cases, the Meterpod device 10 is fully extensible to allow diverse applications to be implemented to accommodate a broad range of devices and protocols.

The Meterpod device 10 system is a microcontroller based interface and provides a cellular communications interface to any power meter with an existing PSTN Modem connection. The Meterpod device 10 is parametrically configured. The Meterpod device 10 has various options that allow connection to an external cellular phone. The Meterpod device 10 allows a connection to an external device via RS232/RS485 physical medium for additional flexibility.

The Meterpod device 10 system has the following interfaces: (1) GSM or CDMA Cellular Modem; (2) PSTN Modem; (3) External Cellular Connection via RS232 port; and (4) External Device Connection via RS232/RS485 port. These interfaces are supported by an Atmel AVR ATmega64, an Atmel AVR ATmega8, a MultiTech Systems SocketModem™, a GSM/GPRS Embedded Data/Fax Wireless Modem, a MultiTech Systems SocketModem™, a CDMA Embedded Data/Fax Wireless Modem, and a MultiTech Systems SocketModem MT5600SMI Family Embedded Modems.

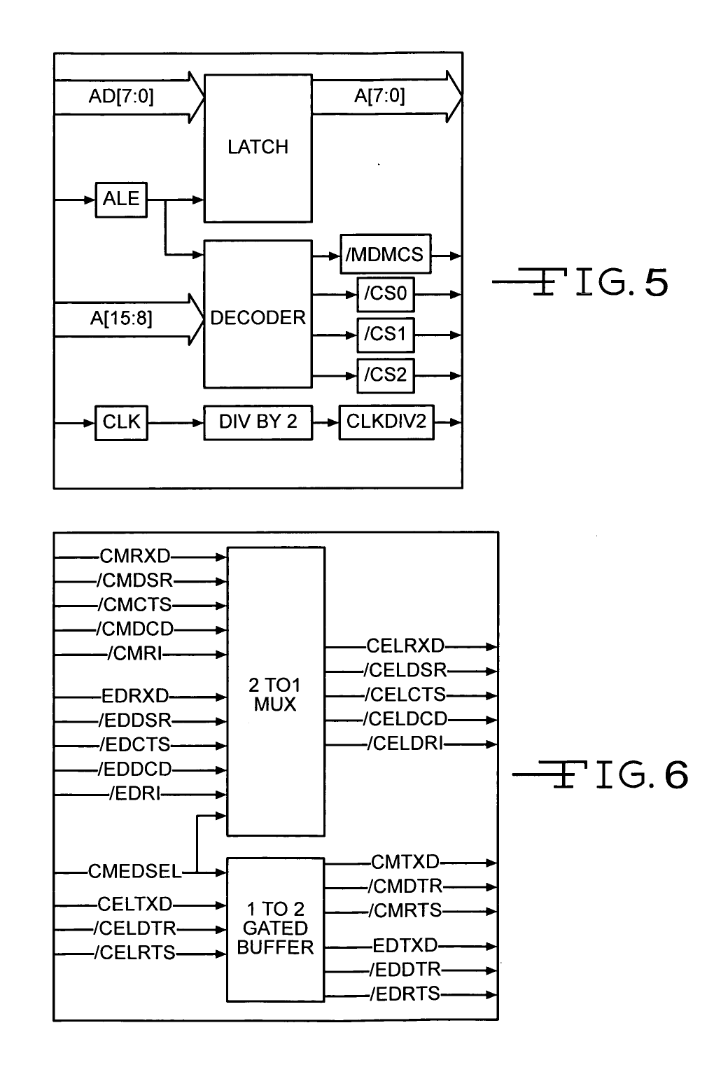

With reference to FIG. 4, the Meterpod device 10 consists of an intelligent single chip microcontroller interface engine, an integrated cellular modem, an integrated PSTN modem, an integrated power supply and optional external connections. The Meterpod device 10 is divided into two communication paths, the cellular and meter side, with an interface engine that acts as a controller and data path supervisor.

The Meterpod device 10 interface engine is based on a single chip microcontroller, an Atmel AVR ATmega2650 with all required resources internal. External circuitry is provided to allow physical level translation as necessary.

The ATmega2650 has the following internal resources: (1) 8 bit Reduced Instruction Set Core, 16MIPS execute speed; (2) Clock Generation; (3) Reset Generation; (4) Brown-out Detection; (5) 64K×8 In-system programmable Flash memory for program storage; (6) 4K×8 Static Random Access Memory; (7) 2K×8 EEPROM memory for parameter storage; (8) Quad programmable USARTS; (9) Master/Slave SPI Serial Interface; (10) Byte oriented Two Wire Interface; (11) Programmable Watchdog Timer with On-chip Oscillator; (12) Two 8 bit counter/timers; (13) Two 16 bit counter/timers; (14) 8 channel 10 bit Analog to Digital converter; and a (15) Real Time Clock.

USART #0 may be used to communicate to the cellular modem. Additional control and status signals may be accessed through port pins on the microcontroller. USART #1 may be used to communicate to the external network connection. Additional protocol select and control signals may be accessed through port pins on the microcontroller.

The Two Wire Interface (TWI) may be used to communicate to the intelligent user interface. This interface has a slave address of 71.

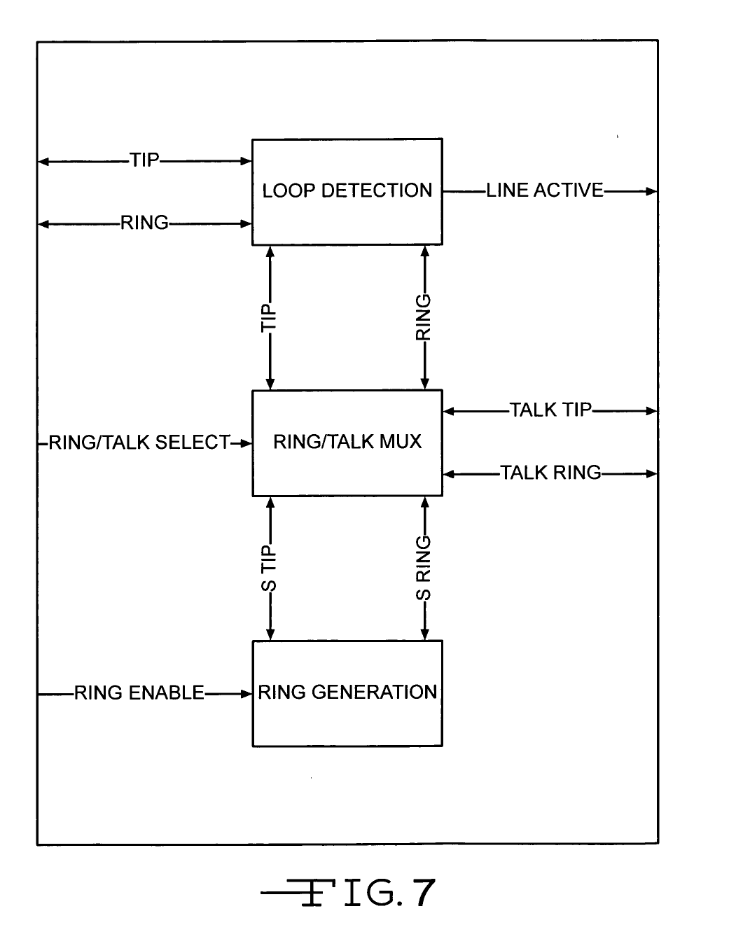

In FIG. 5, the coupler CPLD provides the de-multiplexing of the multiplexed address and data lines and chip select generation.

The chip selects decode the external memory space of the Atmega64. The chip selects have the following range and are used to enable the internal modem and provide expansion for later use.

TABLE 1
Chip Select Address Ranges

| Name | Beginning Address | Ending Address |
|---|---|---|
| /MDMCS | 0x2000 | 0x2FFF |
| /CS0 | 0x3000 | 0x3FFF |
| /CS1 | 0x4000 | 0x7FFF |
| /CS2 | 0x8000 | 0xFFFF |

The Meterpod device 10 provides two connections to a cellular modem using an RS232 interface, one internal and one external through a DB9. The Meterpod device 10 provides an internal cellular modem utilizing the SocketModem™ universal site developed by Multi Tech Systems. This allows either a GSM/GPRS or CDMA cellular modem to be installed. The Meterpod device 10 provides an external modem DB9 connection with RS232 signals to allow an external device to be connected. This device supports a standard AT command set for modem control. In FIG. 6, the switch CPLD provides the multiplexing function that selects the internal or external cellular modem through normal RS232 signals.

TABLE X
Cellular Modem Interface Signals

| Name | Type | Description |
|---|---|---|
| CELTXD | O | Transmit Data to modem |
| CELRXD | I | Receive Data from modem |
| /CELDTR | O | Data Terminal Ready to modem |
| /CELDSR | I | Data Set Ready from modem |
| /CELRTS | O | Request To Send to modem |
| /CELCTS | I | Clear To Send from modem |
| /CELDCD | I | Data Carrier Detect from modem |
| /CELRI | I | Ring Indication from modem |

The Meter Interface provides a standard analog modem (PSTN) connection for use with meters equipped with this interface. This interface also simulates the standard PSTN signals including ring generation. The Meterpod device 10 provides an internal analog modem utilizing the SocketModem ™ universal site developed by Multi Tech Systems. This modem interfaces to the Interface Engine through the expansion memory interface.

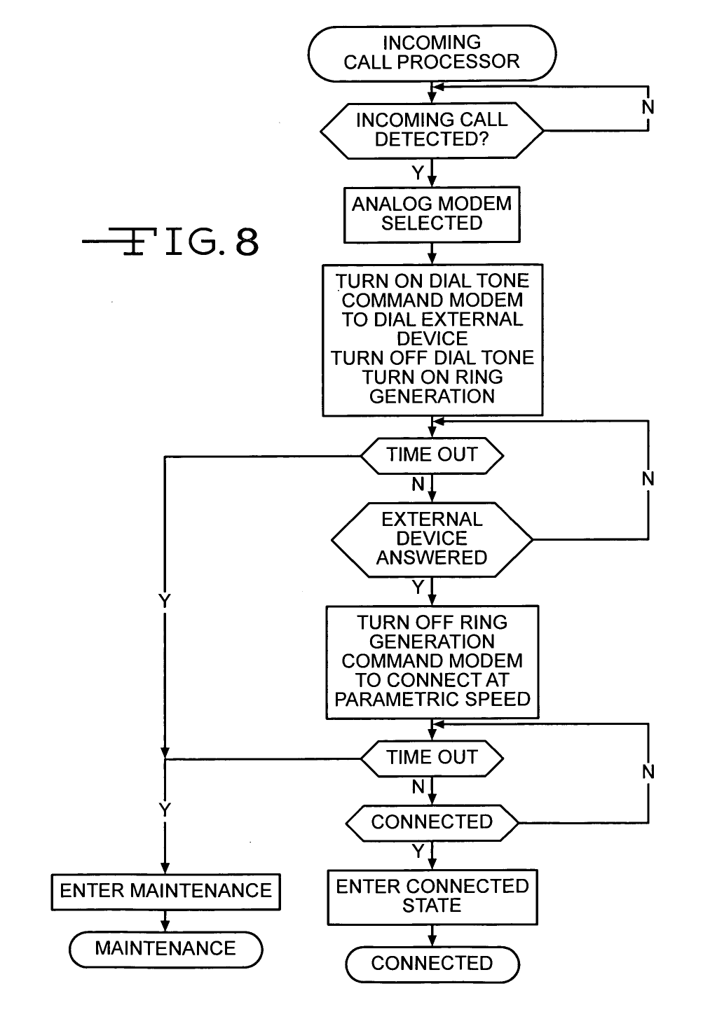

In FIG. 7, the PSTN simulator provides the network voltage source, loop detection, ring generation and ring/talk selection. The Meterpod device 10 provides a local network interface to which an external device may be attached. This interface has the following characteristics: (1) RS232; (2) RS485 Full/Half Duplex; (3) RS422 Full/Half Duplex; (4) DB9 male connector; (5) Protocol selection under software control; (6) Half duplex direction control under software control.

The Meterpod device 10 provides an interface to which an external cellular phone may be attached. This interface has the following characteristics: (1) RS232; (2) DB9 male connector. The Meterpod device 10 also has an internal switching power supply. This supplies all the internal voltages required by the Meterpod device 10 system. The Meterpod device 10 provides an intelligent user interface with LCD 109 and keypad 110 for user feedback and parametric input. The intelligence is provided by a ATmega8 microcontroller. The user interface communicates to the main interface engine through the Two Wire Interface. This interface has a slave address of 72. The display may be a LED backlit liquid crystal display with 2 lines of 16 characters. The keypad consists of 5 keys, an up key, a down key, a left key, a right key and a select key. The Meterpod device 10 provides a three pin connector for input power. The connector has the following pin out: Pin #1—Earth Ground; Pin #2—ACIN; and Pin #3—ACIN.

The Meterpod device 10 provides a DB9 male connector for interfacing to an external cellular phone. The connector has the following pin out: Pin #1—Received Line Signal Detector (DCD); Pin #2—Receive Data (RD); Pin #3—Transmit Data (TD); Pin #4—Data Terminal Ready (DTR); Pin #5—Signal Ground (SG); Pin #6—Data Communications Equipment Ready(DSR); Pin #7—Request to Send (RTS); Pin #8—Clear to Send (CTS); and Pin #9—Ring Indicator (RI).

The Meterpod device 10 provides a DB9 male connector for interfacing to an external device (e.g., local network interface). The connector has the following pin out:

TABLE X
Local Network Interface

| PIN | Description/RS232 | RS485/Full Dup | RS485/Half Duplex |
|---|---|---|---|
| 1 | NC | | |
| 2 | Receive Data (RD) | TX− | TX/RX− |
| 3 | Transmit Data (TD) | TX+ | TX/RX+ |
| 4 | NC | | |
| 5 | Signal Ground (SG) | | Signal Ground (SG) |
| 6 | NC | RX− | |
| 7 | NC | RX+ | |
| 8 | NC | Term | Term |
| 9 | NC | Term | Term |

The cellular antenna connection is provided by an SMA type coaxial connector. the Meterpod device 10 has an expansion connector to allow for further enhancements. This connector contains the signals from the microcontroller's address, data and control buses. The boot monitor is the first section of code that is executed upon a power up. It provides the Power on Self Test (POST) diagnostics, application verification and in-system programmability. The POST tests are executed to ensure the integrity of the microcontroller and its associated peripherals. the tests that may be executed are as follows: (1) Basic CPU test; (2) SRAM address test; (3) SRAM Data test (4) Internal Register Read/Write; (5) Self Test.

The application verification test detects the presence of an application and its integrity by performing a checksum calculation of the application's code section within the internal Flash memory. If a valid application is detected and verified, the boot monitor then allows this code to execute. If an invalid application is detected, the boot monitor remains in boot mode and indicates this condition with an error indication. The boot monitor also provides for in-system application firmware updates. This uses either of the two cellular interfaces to allow for a new application to be installed into the Flash memory.

The sequence of operations performed by the firmware located in the Interface engine includes:

System Wakeup. In all idle times, the Interface Engine is in a sleep state with minimum power being dissipated. The Interface Engine is awoken from this state upon the detection of an incoming call either from the cellular side or the meter side. Upon wakeup, the Interface Engine establishes a connection to the cellular modem.

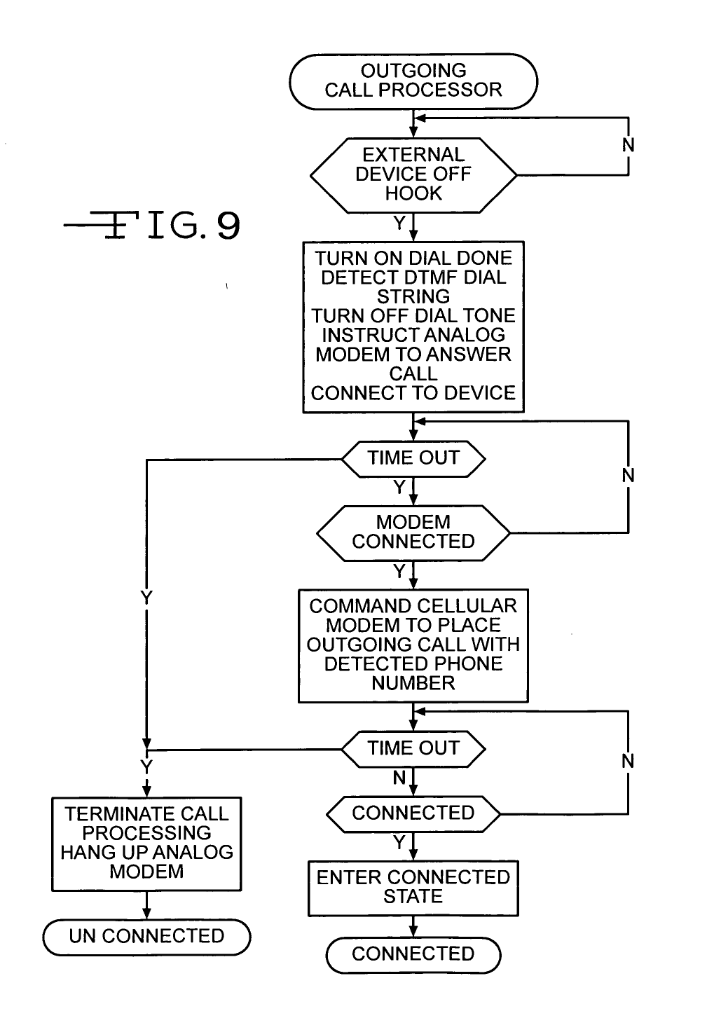

In FIG. 8, an Incoming Call Processing operation is depicted. The Interface Engine checks to see if authentication is required by either matching caller ID numbers, authentication passwords or a combination of both. This feature is established by setting the correct parametric options during system configuration. If authentication has been successfully completed, the incoming call is now established. The Interface Engine generates the necessary signals to establish a call to the meter. If a meter is present and the call is established, the Interface engine then sends the appropriate connect message to the cellular connection. If errors are detected or the meter connection fails, an indication of such is returned to the cellular connection. The data path controller primarily supervises the flow of information from the cellular modem to the meter and vice versa. No translation or protocol conversion is provided at this time. The firmware keeps a history log of exceptions. This log can be interrogated by a command via the cellular connection.

The parameters are stored in an internal Electrically Erasable Programmable Read Only Memory. These parameters can be set from either a host computer via the cellular connection or by using the User Interface.

The Meterpod device 10 provides both internal diagnostics and a history log indicating parametric changes and errors determined during the normal course of operation. The internal test procedures exercise the various sub-system modules contained within the Meterpod device 10. Cellular modem Test determines the connectivity and operation of the cellular modem. Modem Test determines the connectivity and operation of the modem and PSTN simulator. External Network Test determines the communications capability of the external network using a simple loop-back. The history log records all events into a First In First Out memory log. The log contains two kind of entries, parametric changes and errors. Parametric Changes Log records the date and time, parameter number, and new parameter value. This is used to keep track of setup and configuration issues that may arise.

The application software is comprised of the following software components. Meter Pod Control is the component that provides the initialization and overall event processing. Cell Communications Message Handler component provides the control of communications to the cellular modems. Meter Communications Message Handler component provides the control of communications to the modem. External Communications Message Handler component provides the control of communications to the external network communications port. Library Modules components are used to provide basic services needed for system operation. Parameter Handler component provides parameter manipulation including storage, reading and writing. Timer Handler component provides the overall system timer as well as user defined timers. Event Handler component provides the scheduling of events and processing of all queued events. Menu Handler component provides the display and manipulation of the user interface menus. Terminal Handler component provides the terminal emulation needed by the menu handler to display information and receive user input. Protocol Handlers components provide the transmission and reception of commands that have a defined protocol. AT Protocol Handler components provides the protocol generation and parsing of AT type commands used by both the cellular modem and PSTN modem. External Network Protocol Handler component provides the protocol generation and parsing of the external network. This is defaulted to be the standard Entrelogic communications protocol. Device Drivers components provide the basic functionality needed to control the various internal peripherals contained within the ATmega64. USART #0 Driver component provides an interrupt driven driver for the USART #0. USART #1 Driver component provides an interrupt driven driver for the USART #1. TWI Driver component provides an interrupt driven driver for the Two Wire Interface.

Thus for an incoming call procedure, the Meterpod device 10 answers the incoming connection from the cellular modem. The Meterpod device 10 rings the meter and establishes communications with the meter. The Meterpod device 10 allows communications between the host and the meter. The Meterpod device 10 determines a call has ended and performs an orderly shutdown. The Meterpod device 10 detects any errors during this process and logs them accordingly.

In FIG. 9, an outgoing call procedure is depicted. Meter initiates a call by bringing its modem off hook. The Meterpod device 10 answers the call and establishes communications with the meter. The Meterpod device 10 activates the cellular modem and dials the number of the host system. The Meterpod device 10 then establishes a connection and allows communications between the host and the meter. The Meterpod device 10 determines a call has ended and performs an orderly shutdown. The Meterpod device 10 detects any errors during this process and logs them accordingly.

By virtue of the foregoing, the Meterpod device 10 is a digital, remote telecommunications device that transforms analog signals from measurement and monitoring devices such as industrial polyphase utility meters 14 and environmental/security monitoring equipment to digitally transmitted data via a broad array of digital communications options. The Meterpod device 10 provides ultimate flexibility in how it can be configured, which allows for seamless integration into existing applications infrastructure. The Meterpod device 10 has a core processor that inherently provides additional computational capacity beyond the standard functions of the Meterpod device 10. The Meterpod device 10 has the ability to transmit on any cellular band and protocol, including the emerging Short Messaging Service (SMS) protocol. It also has a complete set of network interconnection ports deployed in it that allow for the two-way connection and communication between networks and remote devices. The Meterpod device 10 can not only transmit data from a remote analog device, it can also provide control of the remote device by allowing the conversion of digitally transmitted commands back into the appropriate analog format for use by the remote controlled device.

While the present invention has been illustrated by description of several embodiments and while the illustrative embodiments have been described in considerable detail, it is not the intention of the applicant to restrict or in any way limit the scope of the appended claims to such detail. Additional advantages and modifications may readily appear to those skilled in the art.

What is claimed is:

1. A device, comprising:
an analog modem operatively configured for communication with a local utility meter;
a memory;
a data buffer contained in the memory;
a digital cellular transceiver; and
a controller operatively configured to perform as a communication bridge between a remote host computer via a digital cellular call maintained by the digital cellular transceiver and the local utility meter by buffering received data from a selected one of a group consisting of the local utility meter and the remote host computer and asynchronously relaying the buffered received data to the other of the group.

2. The device of claim 1, further comprising an auxiliary control port operatively configured for digital communication to a control device associated with the local utility meter, the controller further operatively configured to receive a command from the remote host computer via the digital cellular transceiver and to switch digital communication to a respective one of the analog modem and auxiliary control port in response to the command.

3. The device of claim 2, wherein the controller is further operatively configured to enter a maintenance mode in response to the received command.

4. The device of claim 2, further comprising a multiplexer operatively configured for electrical communication with a plurality of local utility meters, the auxiliary control port operatively configured to relay a control signal selecting one of the plurality of local utility meters for communication with the analog modem.

5. The device of claim 4, wherein the controller is further operatively configured to assembly a summary report of sequentially received data from the plurality of local utility meters and to intermittently transmit the summary report via the digital cellular transceiver.

6. The device of claim 5, wherein the controller is further operatively configured to format the summary report per a protocol for short message services via the digital cellular transceiver.

7. The device of claim 2, further comprising a public system telephone network simulator, the controller responsive to an off hook signal from the local utility meter to determine a telephone number from a received Dual Tone Multi-Frequency signal and to initiate a digital cellular telephone call, and to perform data buffering.

8. The device of claim 1, wherein the controller is further operatively configured to convert between a stream communication over the analog modem and a digital packet communication over the digital cellular transceiver.

9. The device of claim 1, wherein the controller is further operatively configured to store a log file in the memory.

10. The device of claim 1, further comprising a local user interface.

11. The device of claim 10, wherein the memory contains parametric data, the local user interface comprises an alphanumeric screen and a keypad sized for manipulation by a gloved hand, the controller further operatively configured to operate in conformance to the stored parametric data, to respond to the keypad to selectively display a selected one of received data from the local utility meter and the stored parametric data.

12. The device of claim 1, further comprising a secondary communication channel, the controller further operatively configured to detect an inability to communicate with the remote host computer via the digital cellular transceiver and to initiate communication via the secondary communication channel.
